(19) United States
(12) Patent Application Publication
(10) Pub. No.: US 2023/0367014 A1
(43) Pub. Date: Nov. 16, 2023

(54) BEAM STEERING TECHNIQUES FOR CORRECTING SCAN LINE COMPRESSION IN LIDAR DEVICES

(71) Applicant: VELODYNE LIDAR USA, INC., San Jose, CA (US)

(72) Inventors: Stephen S. Nestinger, San Jose, CA (US); Mathew Noel Rekow, San Jose, CA (US)

(21) Appl. No.: 17/741,304

(22) Filed: May 10, 2022

(51) Int. Cl. G01S 17/89; G01S 17/32; G01S 7/481

(52) U.S. Cl. CPC G01S 17/89; G01S 17/32; G01S 7/4817

(57) ABSTRACT

A light detection and ranging (LiDAR) device includes at least one illumination source configured to emit illumination light, an optical scanning device disposed in an optical path of the at least one illumination source to redirect the illumination light emitted by the at least one illumination source from the LiDAR device into a three-dimensional (3-D) environment, at least one scanning mechanism configured to rotate the optical scanning device about at least one axis, and at least one controller. The at least one controller is configured to determine a desired scan pattern for the LiDAR device, generate at least one drive waveform corresponding to (i) the desired scan pattern and (ii) a scan line compression profile of the optical scanning device, and operate the at least one scanning mechanism based on the at least one drive waveform to provide the desired scan pattern.

### TECHNICAL FIELD

The present disclosure relates generally to light detection and ranging (“LiDAR”) technology and, more specifically, to beam steering techniques for correcting scan line compression in LiDAR devices.

### BACKGROUND

LiDAR systems measure the attributes of their surrounding environments (e.g., shape of a target, contour of a target, distance to a target, etc.) by illuminating the target with light (e.g., laser light) and measuring the reflected light with sensors. Differences in laser return times and/or wavelengths can then be used to make digital, three-dimensional (“3D”) representations of a surrounding environment. LiDAR technology may be used in various applications including autonomous vehicles, advanced driver assistance systems, mapping, security, surveying, robotics, geology and soil science, agriculture, unmanned aerial vehicles, airborne obstacle detection (e.g., obstacle detection systems for aircraft), etc. Depending on the application and associated field of view, multiple channels or laser beams may be used to produce images in a desired resolution. A LiDAR system with greater numbers of channels can generally generate larger numbers of pixels.

In a multi-channel LiDAR device, optical transmitters can be paired with optical receivers to form multiple “channels.” In operation, each channel's transmitter can emit an optical signal (e.g., laser) into the device's environment, and the channel's receiver can detect the portion of the signal that is reflected back to the channel by the surrounding environment. In this way, each channel can provide “point” measurements of the environment, which can be aggregated with the point measurements provided by the other channel(s) to form a “point cloud” of measurements of the environment.

The measurements collected by a LiDAR channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the wavelength (or frequency) of the return signal(s) reflected by the surface.

In some cases, LiDAR measurements may be used to determine the reflectance of the surface that reflects an optical signal. The reflectance of a surface may be determined based on the intensity of the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

Disclosed herein are beam steering techniques for correcting scan line compression in LiDAR systems and devices.

At least one aspect of the present disclosure is directed to a light detection and ranging (LiDAR) device. The LiDAR device includes at least one illumination source configured to emit illumination light, an optical scanning device disposed in an optical path of the at least one illumination source to redirect the illumination light emitted by the at least one illumination source from the LiDAR device into a three-dimensional (3-D) environment, at least one scanning mechanism configured to rotate the optical scanning device about at least one axis, and at least one controller. The at least one controller is configured to determine a desired scan pattern for the LiDAR device, generate at least one drive waveform corresponding to (i) the desired scan pattern and (ii) a scan line compression profile of the optical scanning device, and operate the at least one scanning mechanism based on the at least one drive waveform to provide the desired scan pattern.

Another aspect of the present disclosure is directed to a vehicle that includes at least one LiDAR device having one or more of the features described above. Each LiDAR device is configured to provide navigation and/or mapping for the vehicle and is disposed in an interior of the vehicle and/or on an exterior of the vehicle.

Another aspect of the present disclosure is directed to a method of operating a light detection and ranging (LiDAR) device. The method includes determining a desired scan pattern for the LiDAR device, emitting illumination light from at least one illumination source, generating at least one drive waveform corresponding to (i) the desired scan pattern and (ii) a scan line compression profile of an optical scanning device disposed in an optical path of the at least one illumination source, and controlling at least one scanning mechanism based on the at least one drive waveform. The optical scanning device is configured to redirect the illumination light emitted by the at least one illumination source from the LiDAR device into a three-dimensional (3-D) environment, and the at least one scanning mechanism is configured to rotate the optical scanning device about at least one axis to provide the desired scan pattern.

Various embodiments of these aspects of the disclosure may include the following features. The at least one scanning mechanism may be controlled (e.g., by the at least one controller) by controlling (i) a first scanning mechanism configured to rotate the optical scanning device about a first axis to deflect the illumination light in a first scan direction and (ii) a second scanning mechanism configured to rotate the optical scanning device about a second axis to deflect the illumination light in a second scan direction. In some embodiments, the second axis is orthogonal to the first axis.

In various embodiments, the scan line compression profile corresponds to a deflection percentage of the optical scanning device over an optical scan range in the first scan direction. In some embodiments, the deflection percentage represents an actual amount of deflection provided by the optical scanning device in the second scan direction relative to a desired amount of deflection to be provided by the optical scanning device in the second scan direction. In certain embodiments, the at least one drive waveform is configured to compensate for differences between the desired amount of deflection and the actual amount of deflection to provide the desired scan pattern.

In some embodiments, the scan line compression profile of the optical scanning device provides an indication of at least one geometrically compressed region in a field of view of the LiDAR device. In certain embodiments, the at least one geometrically compressed region corresponds to at least one portion of the optical scan range in the first scan direction.

In various embodiments, the at least one drive waveform is configured to adjust an amount of deflection provided by the optical scanning device in the second scan direction at a variable rate based on the scan line compression profile. In some embodiments, the at least one drive waveform is configured to adjust the amount of deflection provided by the optical scanning device in the second scan direction at a non-linear rate over the at least one geometrically compressed region. In certain embodiments, the at least one drive waveform is configured to adjust the amount of deflection provided by the optical scanning device in the second scan direction at a substantially linear rate outside of the at least one geometrically compressed region.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is an illustration of an exemplary LiDAR system, in accordance with some embodiments.

FIG. 2A is an illustration of the operation of a LiDAR system, in accordance with some embodiments.

FIG. 2B is an illustration of optical components of a channel of a LiDAR system with a movable mirror, in accordance with some embodiments.

FIG. 2C is an illustration of an example of a 3D LiDAR system, in accordance with some embodiments.

FIG. 3 is an illustration of an example continuous wave (CW) coherent LiDAR system, in accordance with some embodiments.

FIG. 4 is an illustration of an example frequency modulated continuous wave (FMCW) coherent LiDAR system, in accordance with some embodiments.

FIG. 5A is a plot of a frequency chirp as a function of time in a transmitted laser signal and reflected signal, in accordance with some embodiments.

FIG. 5B is a plot illustrating a beat frequency of a mixed signal, in accordance with some embodiments.

FIG. 6 is a functional block diagram of a LiDAR system including a single reflective surface, in accordance with some embodiments.

FIG. 7A is an illustration of an ideal scan pattern of a LiDAR system, in accordance with some embodiments.

FIG. 7B is an illustration of an actual scan pattern of a LiDAR system, in accordance with some embodiments.

FIG. 8 is an illustration of a compression profile of a LiDAR system, in accordance with some embodiments.

FIG. 9 is an illustration of an ideal scan pattern of a LiDAR system and a corresponding drive waveform, in accordance with some embodiments.

FIG. 10 is a flow diagram of a method for generating a drive waveform for a LiDAR system, in accordance with some embodiments.

FIG. 11 is a flow diagram of a method for operating a LiDAR system, in accordance with some embodiments.

FIG. 12 is a diagram of a vehicle including a plurality of sensors, in accordance with some embodiments.

FIG. 13 is a diagram of an exemplary hardware and software system implementing the systems and methods described herein, in accordance with some embodiments.

FIG. 14 is a block diagram of a computing device/information handling system, in accordance with some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Exemplary systems and methods for correcting scan line compression in LiDAR systems using single reflective surfaces are provided herein. In at least one embodiment, a drive waveform is generated to adjust the deflection of the reflective surface to correct the scan line compression. In one example, the deflection of the reflective surface is adjusted by the drive waveform at a variable rate. In some examples, the deflection of the reflective surface is adjusted at a non-linear rate over one or more geometrically compressed regions of the field of view (“FOV”) of the LiDAR system. By correcting scan line compression, the resolution and/or accuracy of the collected scan data can be increased. Likewise, the quality of point clouds and images derived from the scan data may be improved.

### Some Examples of LiDAR Systems

A LiDAR system may be used to measure the shape and contour of the environment surrounding the system. LiDAR systems may be applied to numerous applications including autonomous navigation and aerial mapping of surfaces. In general, a LiDAR system emits light that is subsequently reflected by objects within the environment in which the system operates. In some examples, the LiDAR system is configured to emit light pulses. The time each pulse travels from being emitted to being received (i.e., time-of-flight, “TOF” or “ToF”) may be measured to determine the distance between the LiDAR system and the object that reflects the pulse. In other examples, the LiDAR system can be configured to emit continuous wave (CW) light. The wavelength (or frequency) of the received, reflected light may be measured to determine the distance between the LiDAR system and the object that reflects the light. In some examples, LiDAR systems can measure the speed (or velocity) of objects. The science of LiDAR systems is based on the physics of light and optics.

In a LiDAR system, light may be emitted from a rapidly firing laser. Laser light travels through a medium and reflects off points of surfaces in the environment (e.g., surfaces of buildings, tree branches, vehicles, etc.). The reflected light energy returns to a LiDAR detector where it may be recorded and used to map the environment.

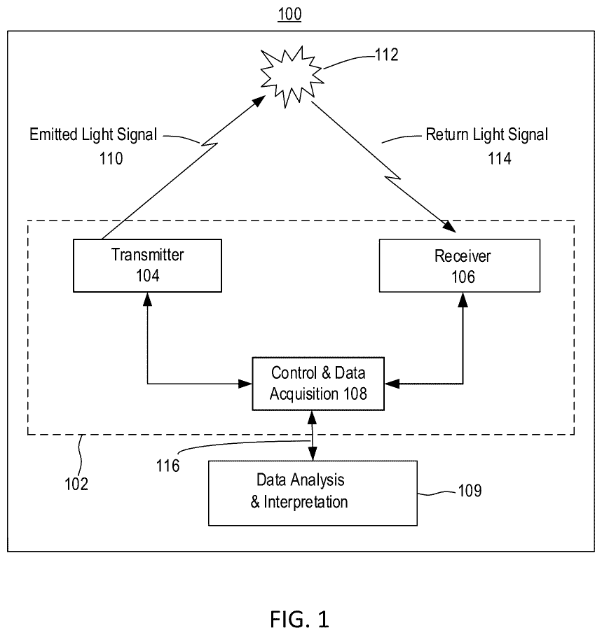

FIG. 1 depicts the operation of a LiDAR system 100, according to some embodiments. In the example of FIG. 1, the LiDAR system 100 includes a LiDAR device 102, which may include a transmitter 104 that generates and emits a light signal 110, a receiver 106 that detects a return light signal 114, and a control & data acquisition module 108. The transmitter 104 may include a light source (e.g., laser), electrical components operable to activate (e.g., drive) and deactivate the light source in response to electrical control signals, and optical components adapted to shape and redirect the light emitted by the light source. The receiver 106 may include an optical detector (e.g., photodiode) and optical components adapted to shape return light signals 114 and direct those signals to the detector. In some implementations, one or more optical components (e.g., lenses, mirrors, etc.) may be shared by the transmitter and the receiver. The LiDAR device 102 may be referred to as a LiDAR transceiver or “channel.” In operation, the emitted (e.g., illumination) light signal 110 propagates through a medium and reflects off an object(s) 112, whereby a return light signal 114 propagates through the medium and is received by receiver 106.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 determines (e.g., measures) particular characteristics of the return light signal 114 detected by the receiver 106. For example, the control & data acquisition module 108 may measure the intensity of the return light signal 114 using any suitable technique.

A LiDAR transceiver 102 may include one or more optical lenses and/or mirrors (not shown) to redirect and shape the emitted light signal 110 and/or to redirect and shape the return light signal 114. The transmitter 104 may emit a laser beam (e.g., a beam having a plurality of pulses in a particular sequence). Design elements of the receiver 106 may include its horizontal FOV and its vertical FOV. One skilled in the art will recognize that the FOV parameters effectively define the visibility region relating to the specific LiDAR transceiver 102. More generally, the horizontal and vertical FOVs of a LiDAR system 100 may be defined by a single LiDAR device (e.g., sensor) or may relate to a plurality of configurable sensors (which may be exclusively LiDAR sensors or may include different types of sensors). The FOV may be considered a scanning area for a LiDAR system 100. A scanning mirror and/or rotating assembly may be utilized to obtain a scanned FOV.

In some implementations, the LiDAR system 100 may include or be electronically coupled to a data analysis & interpretation module 109, which may receive outputs (e.g., via connection 116) from the control & data acquisition module 108 and perform data analysis functions on those outputs. The connection 116 may be implemented using a wireless or non-contact communication technique.

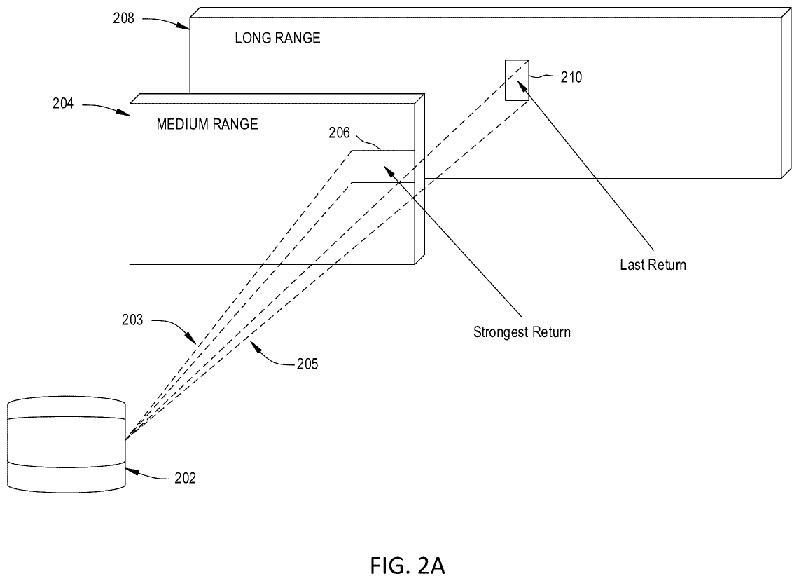

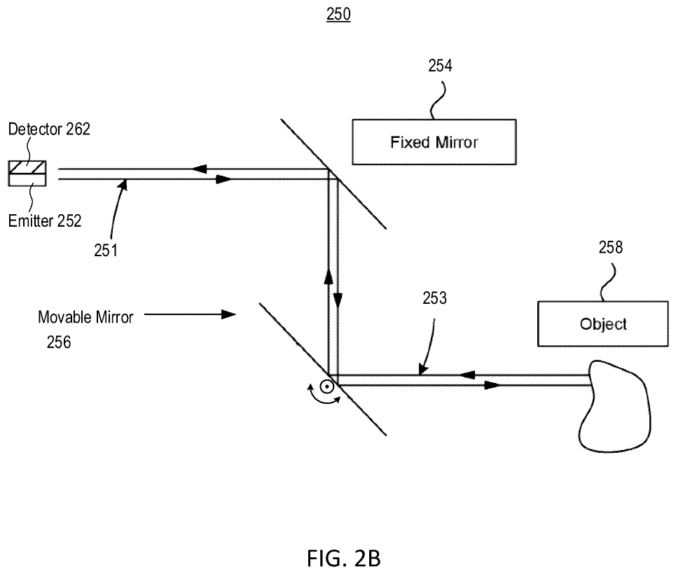

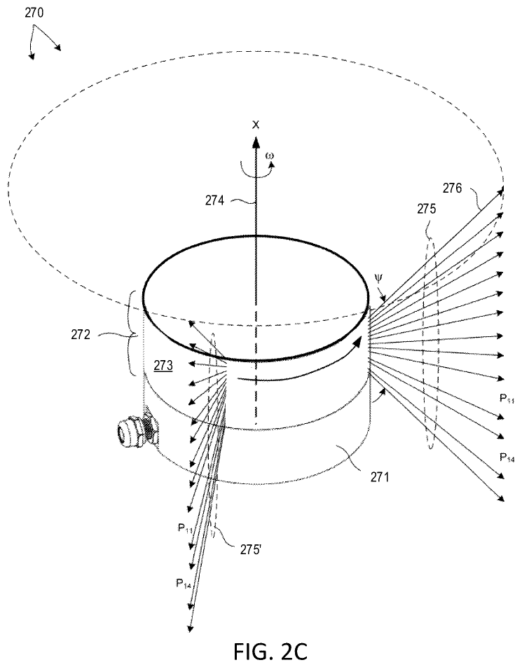

FIG. 2A illustrates the operation of a LiDAR system 202, in accordance with some embodiments. In the example of FIG. 2A, two return light signals 203 and 205 are shown. Laser beams generally tend to diverge as they travel through a medium. Due to the laser's beam divergence, a single laser emission may hit multiple objects at different ranges from the LiDAR system 202, producing multiple return signals 203, 205. The LiDAR system 202 may analyze multiple return signals 203, 205 and report one of the return signals (e.g., the strongest return signal, the last return signal, etc.) or more than one (e.g., all) of the return signals. In the example of FIG. 2A, LiDAR system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and a stronger received signal strength compared with return signal 205. In both single- and multiple-return LiDAR systems, it is important that each return signal is accurately associated with the transmitted light signal so that one or more attributes of the object that reflect the light signal (e.g., range, velocity, reflectance, etc.) can be correctly calculated.

Some embodiments of a LiDAR system may capture distance data in a two-dimensional (“2D”) (e.g., single plane) point cloud manner. These LiDAR systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the LiDAR system to achieve 90-180-360 degrees of azimuth (horizontal) view while simplifying both the system design and manufacturability. Many applications require more data than just a 2D plane. The 2D point cloud may be expanded to form a 3D point cloud, in which multiple 2D point clouds are used, each pointing at a different elevation (e.g., vertical) angle. Design elements of the receiver of the LiDAR system 202 may include the horizontal FOV and the vertical FOV.

FIG. 2B depicts a LiDAR system 250 with a movable (e.g., oscillating) mirror, according to some embodiments. In the example of FIG. 2B, the LiDAR system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. Design elements of the LiDAR system 250 include the horizontal FOV and the vertical FOV, which define a scanning area.

FIG. 2C depicts a 3D LiDAR system 270, according to some embodiments. In the example of FIG. 2C, the 3D LiDAR system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D LiDAR system 270 includes a LiDAR transceiver 102 operable to emit laser beams 276 through the cylindrical shell element 273 of the upper housing 272. In the example of FIG. 2C, each individual arrow in the sets of arrows 275, 275′ directed outward from the 3D LiDAR system 270 represents a laser beam 276 emitted by the 3D LiDAR system. Each beam of light emitted from the system 270 may diverge slightly, such that each beam of emitted light forms a cone of illumination light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D LiDAR system 270. The direction of each emitted beam may be determined by the angular orientation w of the transceiver's transmitter 104 with respect to the system's central axis 274 and by the angular orientation w of the transmitter's movable mirror 256 with respect to the mirror's axis of oscillation (or rotation). For example, the direction of an emitted beam in a horizontal dimension may be determined by the transmitter's angular orientation w, and the direction of the emitted beam in a vertical dimension may be determined by the angular orientation w of the transmitter's movable mirror. Alternatively, the direction of an emitted beam in a vertical dimension may be determined the transmitter's angular orientation w, and the direction of the emitted beam in a horizontal dimension may be determined by the angular orientation w of the transmitter's movable mirror. (For purposes of illustration, the beams of light 275 are illustrated in one angular orientation relative to a non-rotating coordinate frame of the 3D LiDAR system 270 and the beams of light 275′ are illustrated in another angular orientation relative to the non-rotating coordinate frame.)

The 3D LiDAR system 270 may scan a particular point (e.g., pixel) in its field of view by adjusting the orientation ω of the transmitter and the orientation ψ of the transmitter's movable mirror to the desired scan point (ω, ψ) and emitting a laser beam from the transmitter 104. Likewise, the 3D LiDAR system 270 may systematically scan its field of view by adjusting the orientation ω of the transmitter and the orientation ψ of the transmitter's movable mirror to a set of scan points (ωᵢ, ψⱼ) and emitting a laser beam from the transmitter 104 at each of the scan points.

Assuming that the optical component(s) (e.g., movable mirror 256) of a LiDAR transceiver remain stationary during the time period after the transmitter 104 emits a laser beam 110 (e.g., a pulsed laser beam or “pulse” or a CW laser beam) and before the receiver 106 receives the corresponding return beam 114, the return beam generally forms a spot centered at (or near) a stationary location “L0” on the detector. This time period is referred to herein as the “ranging period” of the scan point associated with the transmitted beam 110 and the return beam 114.

In many LiDAR systems, the optical component(s) of a LiDAR transceiver do not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location “Li” of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the transmitted light. The distance between the location “Li” of the spot formed by the return beam and the nominal location “L0” of the spot that would have been formed absent the intervening rotation of the optical component(s) during the ranging period is referred to herein as “walk-off.”

### Some Examples of Continuous Wave (CW) LiDAR Systems

As discussed above, some LiDAR systems may use a continuous wave (CW) laser to detect the range and/or velocity of targets, rather than pulsed TOF techniques. Such systems include continuous wave (CW) coherent LiDAR systems and frequency modulated continuous wave (FMCW) coherent LiDAR systems. For example, any of the LiDAR systems 100, 202, 250, and 270 described above can be configured to operate as a CW coherent LiDAR system or an FMCW coherent LiDAR system.

LiDAR systems configured to operate as CW or FMCW systems can avoid the eye safety hazards of high peak powers associated with pulsed LiDAR systems. In addition, coherent detection may be more sensitive than direct detection and can offer better performance, including single-pulse velocity measurement and immunity to interference from solar glare and other light sources—including other LiDAR systems and devices.

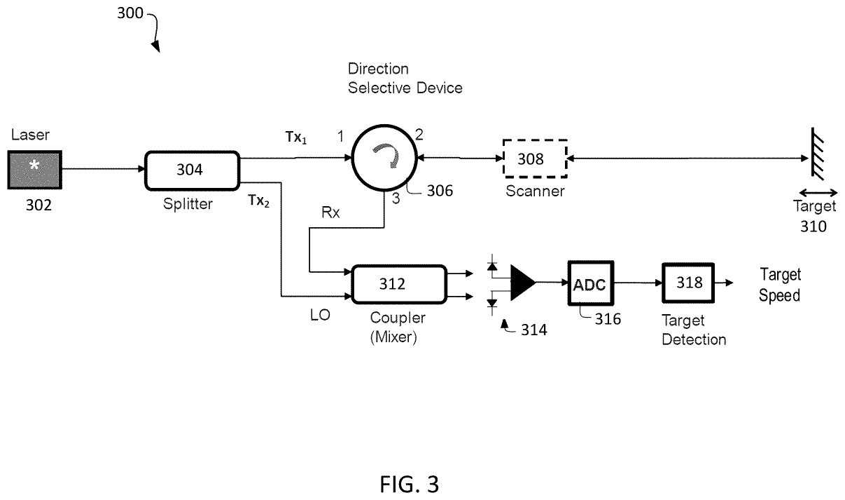

FIG. 3 illustrates an exemplary CW coherent LiDAR system 300 configured to determine the radial velocity of a target. LiDAR system 300 includes a laser 302 configured to produce a laser signal which is provided to a splitter 304. The laser 302 may provide a laser signal having a substantially constant laser frequency.

In one example, the splitter 304 provides a first split laser signal Tx1 to a direction selective device 306, which provides (e.g., forwards) the signal Tx1 to a scanner 308. In some examples, the direction selective device 306 is a circulator. The scanner 308 uses the first laser signal Tx1 to transmit light emitted by the laser 302 and receives light reflected by the target 310 (e.g., “reflected light” or “reflections”). The reflected light signal Rx is provided (e.g., passed back) to the direction selective device 306. The second laser signal Tx2 and reflected light signal Rx are provided to a coupler (also referred to as a mixer) 312. The mixer may use the second laser signal Tx2 as a local oscillator (LO) signal and mix it with the reflected light signal Rx. The mixer 312 may be configured to mix the reflected light signal Rx with the local oscillator signal LO. The mixer 312 may provide the mixed optical signal to a differential photodetector 314, which may generate an electrical signal representing the beat frequency f_{beat} of the mixed optical signals, where f_{beat}=|Tx2−Rx| (the absolute value of the difference between the amplitudes of the mixed optical signals). In some embodiments, the current produced by the differential photodetector 314 based on the mixed light may be proportional to or otherwise indicate the beat frequency f_{beat}. The current may be converted to voltage by an amplifier (e.g., a transimpedance amplifier (TIA)), which may be provided (e.g., fed) to an analog-to-digital converter (ADC) 316 configured to convert the analog voltage signal to digital samples for a target detection module 318. The target detection module 318 may be configured to determine (e.g., calculate) the radial velocity of the target 310 based on the digital sampled signal with beat frequency f_{beat}.

In one example, the target detection module 318 may identify Doppler frequency shifts using the beat frequency f_{beat} and determine the radial velocity of the target 310 based on those shifts. For example, the velocity of the target 310 can be calculated using the following relationship:

$${f}_{d} = \frac{2}{λ} {v}_{t}$$

where, f_{d} is the Doppler frequency shift, λ is the wavelength of the laser signal, and vₜ is the radial velocity of the target 310. In some examples, the direction of the target 310 is indicated by the sign of the Doppler frequency shift f_{d}. For example, a positive signed Doppler frequency shift may indicate that the target 310 is traveling towards the system 300 and a negative signed Doppler frequency shift may indicate that the target 310 is traveling away from the system 300.

In one example, a Fourier Transform calculation is performed using the digital samples from the ADC 316 to recover the desired frequency content (e.g., the Doppler frequency shift) from the digital sampled signal. For example, a controller (e.g., target detection module 318) may be configured to perform a Discrete Fourier Transform (DFT) on the digital samples. In certain examples, a Fast Fourier Transform (FFT) can be used to calculate the DFT on the digital samples. In some examples, the Fourier Transform calculation (e.g., DFT) can be performed iteratively on different groups of digital samples to generate a target point cloud.

While the LiDAR system 300 is described above as being configured to determine the radial velocity of a target, it should be appreciated that the system can be configured to determine the range and/or radial velocity of a target. For example, the LiDAR system 300 can be modified to use laser chirps to detect the velocity and/or range of a target.

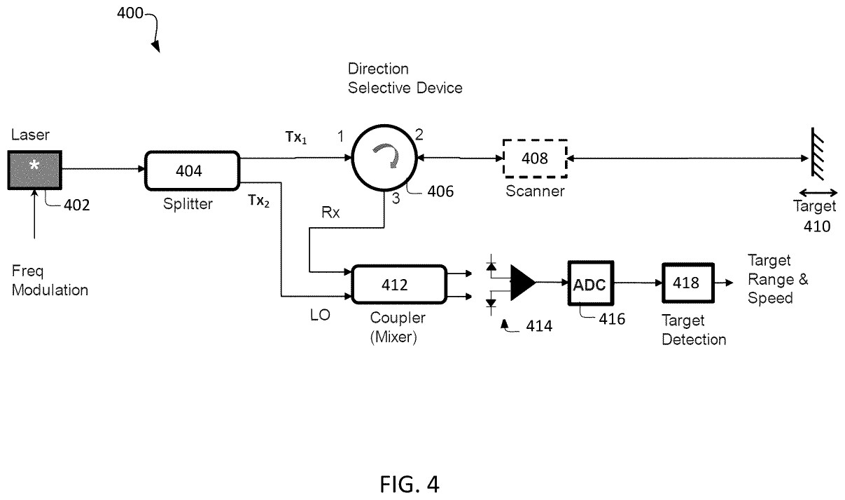

FIG. 4 illustrates an exemplary FMCW coherent LiDAR system 400 configured to determine the range and/or radial velocity of a target. LiDAR system 400 includes a laser 402 configured to produce a laser signal which is fed into a splitter 404. The laser is “chirped” (e.g., the center frequency of the emitted laser beam is increased (“ramped up” or “chirped up”) or decreased (“ramped down” or “chirped down”) over time or, equivalently, the central wavelength of the emitted laser beam changes with time within a waveband). In various embodiments, the laser frequency is chirped quickly such that multiple phase angles are attained. In one example, the frequency of the laser signal is modulated by changing the laser operating parameters (e.g., current/voltage) or using a modulator included in the laser source 402; however, in other examples, an external modulator can be placed between the laser source 402 and the splitter 404.

In other examples, the laser frequency can be “chirped” by modulating the phase of the laser signal (or light) produced by the laser 402. In one example, the phase of the laser signal is modulated using an external modulator placed between the laser source 402 and the splitter 404; however, in some examples, the laser source 402 may be modulated directly by changing operating parameters (e.g., current/voltage) or including an internal modulator. Similar to frequency chirping, the phase of the laser signal can be increased (“ramped up”) or decreased (“ramped down”) over time.

Some examples of systems with FMCW-based LiDAR sensors have been described. However, the techniques described herein may be implemented using any suitable type of LiDAR sensors including, without limitation, any suitable type of coherent LiDAR sensors (e.g., phase-modulated coherent LiDAR sensors). With phase-modulated coherent LiDAR sensors, rather than chirping the frequency of the light produced by the laser (as described above with reference to FMCW techniques), the LiDAR system may use a phase modulator placed between the laser 402 and the splitter 404 to generate a discrete phase modulated signal, which may be used to measure range and radial velocity.

As shown, the splitter 404 provides a first split laser signal Tx1 to a direction selective device 406, which provides (e.g., forwards) the signal Tx1 to a scanner 408. The scanner 408 uses the first laser signal Tx1 to transmit light emitted by the laser 402 and receives light reflected by the target 410. The reflected light signal Rx is provided (e.g., passed back) to the direction selective device 406. The second laser signal Tx2 and reflected light signal Rx are provided to a coupler (also referred to as a mixer) 412. The mixer may use the second laser signal Tx2 as a local oscillator (LO) signal and mix it with the reflected light signal Rx. The mixer 412 may be configured to mix the reflected light signal Rx with the local oscillator signal LO to generate a beat frequency f_{beat}. The mixed signal with beat frequency f_{beat} may be provided to a differential photodetector 414 configured to produce a current based on the received light. The current may be converted to voltage by an amplifier (e.g., a transimpedance amplifier (TIA)), which may be provided (e.g., fed) to an analog-to-digital converter (ADC) 416 configured to convert the analog voltage to digital samples for a target detection module 418. The target detection module 418 may be configured to determine (e.g., calculate) the range and/or radial velocity of the target 410 based on the digital sampled signal with beat frequency f_{beat}.

Laser chirping may be beneficial for range (distance) measurements of the target. In comparison, Doppler frequency measurements are generally used to measure target velocity. Resolution of distance can depend on the bandwidth size of the chirp frequency band such that greater bandwidth corresponds to finer resolution, according to the following relationships:

$$\begin{matrix}\begin{matrix}Range resolution : & Δ R = \frac{c}{2 B W} & ( given a perfectly linear chirp ) , and\end{matrix} \\ \begin{matrix}Range : & R = \frac{{f}_{beat} {cT}_{Chirp Ramp}}{2 B W}\end{matrix}\end{matrix}$$

where c is the speed of light, BW is the bandwidth of the chirped laser signal, f_{beat} is the beat frequency, and T_{ChirpRamp} is the time period during which the frequency of the chirped laser ramps up (e.g., the time period corresponding to the up-ramp portion of the chirped laser). For example, for a distance resolution of 3.0 cm, a frequency bandwidth of 5.0 GHz may be used. A linear chirp can be an effective way to measure range and range accuracy can depend on the chirp linearity. In some instances, when chirping is used to measure target range, there may be range and velocity ambiguity. In particular, the reflected signal for measuring velocity (e.g., via Doppler) may affect the measurement of range. Therefore, some exemplary FMCW coherent LiDAR systems may rely on two measurements having different slopes (e.g., negative and positive slopes) to remove this ambiguity. The two measurements having different slopes may also be used to determine range and velocity measurements simultaneously.

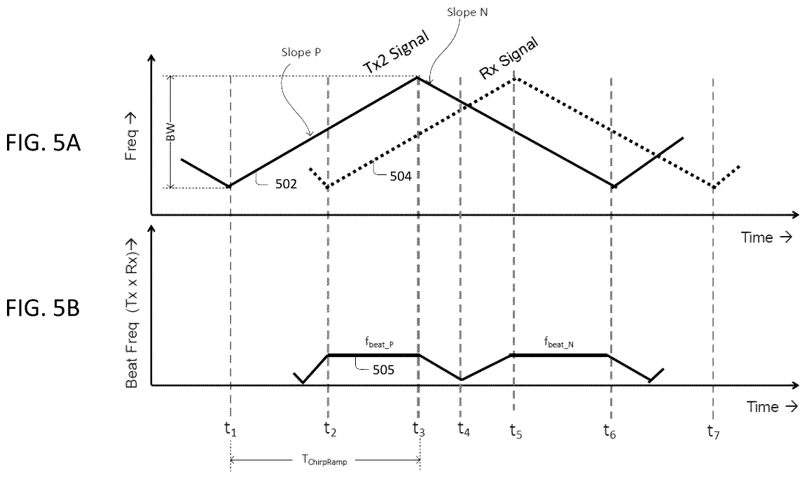

FIG. 5A is a plot of ideal (or desired) frequency chirp as a function of time in the transmitted laser signal Tx (e.g., signal Tx2), depicted in solid line 502, and reflected light signal Rx, depicted in dotted line 504. As depicted, the ideal Tx signal has a positive linear slope between time t1 and time t3 and a negative linear slope between time t3 and time t6. Accordingly, the ideal reflected light signal Rx returned with a time delay td of approximately t2-t1 has a positive linear slope between time t2 and time t5 and a negative linear slope between time t5 and time t7.

FIG. 5B is a plot illustrating the corresponding ideal beat frequency f_{beat} 505 of the mixed signal Tx2×Rx. Note that the beat frequency f_{beat} 505 has a constant value between time t2 and time t3 (corresponding to the overlapping up-slopes of signals Tx2 and Rx) and between time t5 and time t6 (corresponding to the overlapping down-slopes of signals Tx2 and Rx).

The positive slope (“Slope P”) and the negative slope (“Slope N”) (also referred to as positive ramp (or up-ramp) and negative ramp (or down-ramp), respectively) can be used to determine range and/or velocity. In some instances, referring to FIGS. 5A-5B, when the positive and negative ramp pair is used to measure range and velocity simultaneously, the following relationships are utilized:

$$\begin{matrix}\begin{matrix}Range : & R = \frac{{cT}_{Chirp Ramp} \frac{( {f}_{beat\_P} + {f}_{beat\_N} )}{2}}{2 B W} , and\end{matrix} \\ \begin{matrix}Velocity : & V = \frac{λ \frac{( {f}_{beat\_P} + {f}_{beat\_N} )}{2}}{2}\end{matrix}\end{matrix}$$

where f_{beat_P} and f_{beat_N} are beat frequencies generated during positive (P) and negative (N) slopes of the chirp 502 respectively and λ is the wavelength of the laser signal.

In one example, the scanner 408 of the LiDAR system 400 is used to scan the environment and generate a target point cloud from the acquired scan data. In some examples, the LiDAR system 400 can use processing methods that include performing one or more Fourier Transform calculations, such as a Fast Fourier Transform (FFT) or a Discrete Fourier Transform (DFT), to generate the target point cloud from the acquired scan data. Being that the system 400 is capable of measuring range, each point in the point cloud may have a three-dimensional location (e.g., x, y, and z) in addition to radial velocity. In some examples, the x-y location of each target point corresponds to a radial position of the target point relative to the scanner 408. Likewise, the z location of each target point corresponds to the distance between the target point and the scanner 408 (e.g., the range). In one example, each target point corresponds to one frequency chirp 502 in the laser signal. For example, the samples collected by the system 400 during the chirp 502 (e.g., t1 to t6) can be processed to generate one point in the point cloud.

### Beam Steering Techniques to Reduce Scan Line Compression

As described above, pulsed LiDAR systems and coherent LiDAR systems can include scanning mirrors (e.g., moveable mirror 256) that are actuated to scan in one or more dimensions (e.g., horizontally and/or vertically). In some examples, such LiDAR systems can include a single reflective surface that is actuated to scan in both the horizontal and vertical dimensions. For example, it may be advantageous to use a single reflective surface to reduce the size and/or cost of LiDAR systems. The single reflective surface may be a mirror, a solid-state optical component (e.g., polygon), or any suitable surface/component capable of providing deflections in multiple dimensions. However, LiDAR systems using a single reflective surface can experience scan line compression. In some cases, such scan line compression can degrade the resolution and/or accuracy of the measurements collected by the LiDAR system.

As such, improved systems and methods for correcting scan line compression in LiDAR systems using single reflective surfaces are provided herein. In at least one embodiment, a drive waveform is generated to adjust the deflection of the reflective surface to correct scan line compression. In one example, the deflection of the reflective surface is adjusted by the drive waveform at a variable rate. In some examples, the deflection of the reflective surface is adjusted at a non-linear rate over one or more geometrically compressed regions of the FOV of the LiDAR system.

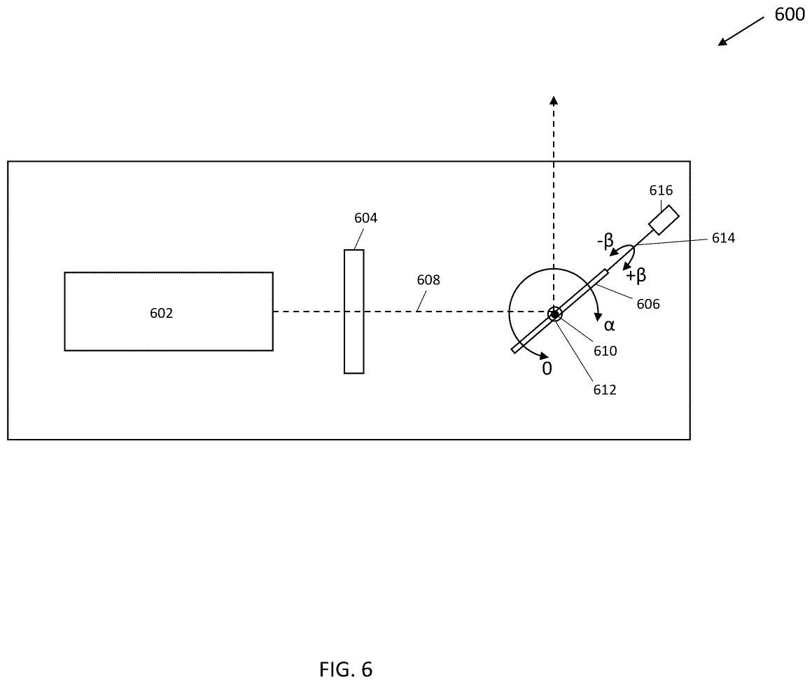

FIG. 6 is a schematic diagram of an exemplary LiDAR system 600, according to some embodiments. In one example, the LiDAR system 600 can be a pulsed TOF LiDAR system or an FMCW LiDAR system. As shown, the LiDAR system 600 includes a light emission engine 602, a lens 604, and a scanning mirror 606. In some examples, the LiDAR system 600 corresponds to at least a portion of the LiDAR system 250 of FIG. 2B. For example, the light emission engine 602 may correspond to the emitter 252 and the scanning mirror 606 may correspond to the moveable mirror 256.

As shown, the light emission engine 602 is configured to provide a transmit beam 608 that passes through the lens 604 and is reflected by the scanning mirror 606. In one example, the scanning mirror 606 is rotated about a first axis 610 to scan the transmit beam 608 in a horizontal direction. The scanning mirror 606 may be rotated about the first axis 610 via a first actuator 612. In some examples, the scanning mirror 606 is rotated about the first axis 610 to scan the transmit beam 608 over an optical scan range of 0 to α in the horizontal direction. In one example, α is 120 degrees. It should be appreciated that the horizontal optical scan range can be defined differently. For example, the horizontal optical scan range may be defined as −α/2 to +α/2. Likewise, the scanning mirror 606 may be rotated about a second axis 614 to scan the transmit beam 608 in a vertical direction. The scanning mirror 606 may be rotated about the second axis 614 via a second actuator 616. In some examples, the scanning mirror 606 is rotated about the second axis 614 to scan the transmit beam 608 over an optical scan range of −β to +β in the vertical direction. In one example, β is 1 degree. It should be appreciated that the physical rotation range(s) of the scanning mirror 606 may be much smaller than the corresponding optical scan ranges.

The scanning mirror 606 can be rotated about the first axis 610 and the second axis 614 simultaneously to provide a scan pattern. In one example, the first actuator 612 is configured to receive a first control signal from a controller (e.g., control & data acquisition module 108) to control the rotation of the scanning mirror 606 about the first axis 610. Similarly, the second actuator 616 may be configured to receive a second control signal from the controller to control the rotation of the scanning mirror 606 about the second axis 614. In other examples, the actuators 612, 616 may receive one or more common control signals representative of the scan pattern.

In some examples, the position of the scanning mirror 606 is dynamically adjusted in accordance with the scan pattern using one or more flexure components. For example, the scanning mirror 606 can be included in a scanning mirror mechanism that includes magnets, coils, structures, position/rotation sensors, and flexures. Each flexure can be made of thin metal or a bundle of wires (e.g., parallel wires) (e.g., non-twisted parallel wires), which is structurally fixed at two ends and allowed to twist with the mirror 606 and the mirror mechanisms. Any suitable mechanisms and techniques may be used to control the position of the mirror 606 including, without limitation, the techniques described in U.S. patent application Ser. No. 17/392,080, titled “Scanning Mirror Mechanisms for LiDAR Systems, and Related Methods and Apparatus” and filed on Aug. 2, 2021, which is hereby incorporated by reference herein in its entirety. In certain examples, the scanning mirror 606 is a dual-axis micro-electromechanical system (MEMS) mirror.

While the example described above includes one transmit beam 608, it should be appreciated that the scanning mirror 606 can reflect multiple transmit beams simultaneously. For example, the light emission engine 602 may be configured to provide a plurality of transmit beams that are reflected by the scanning mirror 606 to provide the scan pattern. Any suitable number of light sources may be included in the light emission engine 602 (e.g., 1-128 light sources or more). In some embodiments, some or all of the light sources may be arranged in an array (e.g., a one-dimensional (“1-D”) array), and each light source in the array may be configured to emit a transmit beam onto the surface of a scanning mirror 606. In some embodiments, the light sources of the array may be aligned along an axis that is parallel to the first axis 610 of the scanning mirror 606. In other examples, the LiDAR system 600 may include multiple instances of the light engine 602 to provide a plurality of transmit beams.

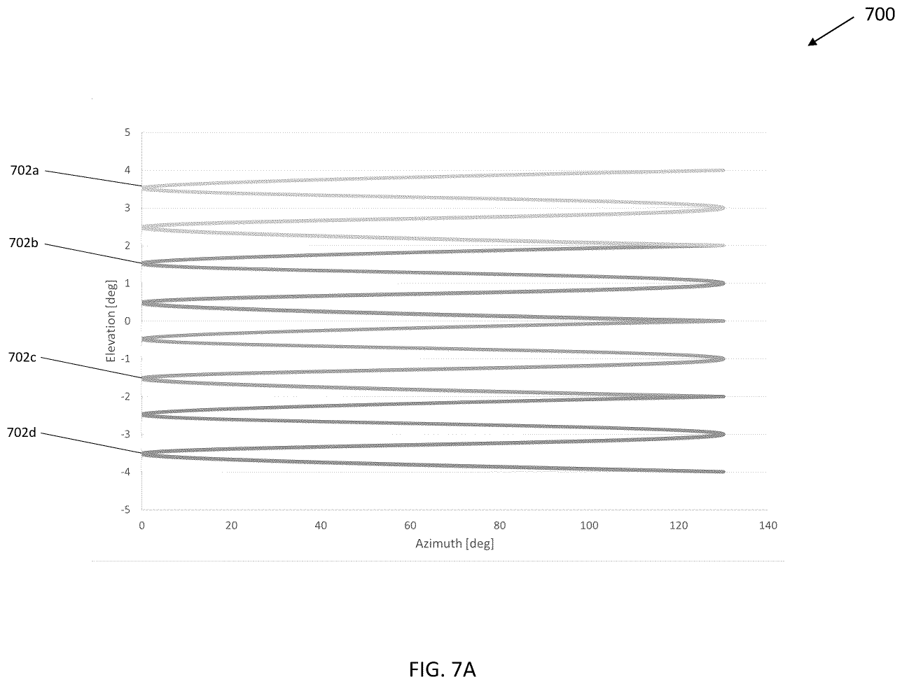

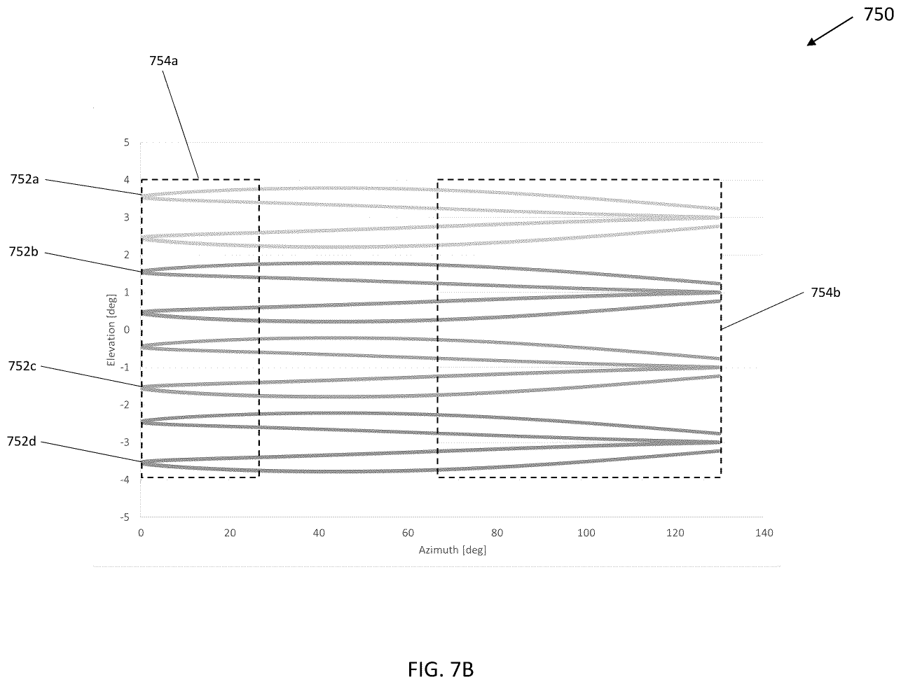

FIG. 7A illustrates an ideal (or desired) scan pattern 700 of the LiDAR system 600, according to some embodiments. As shown, the scan pattern 700 includes a plurality of partial scan patterns 702. Each partial scan pattern may correspond to a different channel of the LiDAR system. In one example, each partial scan pattern corresponds to the trajectory of a transmit beam provided by a corresponding transmitter (e.g., light emission engine 602). The transmit beams are reflected by the scanning mirror 606 in different, parallel vertical regions of the FOV of the LiDAR system. For example, a first transmit beam corresponding to the first partial scan pattern 702a may be provided by a first transmitter and reflected in a first vertical region of the FOV, a second transmit beam corresponding to the second partial scan pattern 702b may be provided by a second transmitter and reflected in a second vertical region of the FOV, and so on. In other examples, the light emission engine 602 can be configured to provide each of the transmit beams (e.g., using an array of light sources).

As described above, the scanning mirror 606 may be rotated about the first axis 610 to scan over an optical scan range of 0 to α in the horizontal direction and rotated about a second axis 614 to scan over an optical scan range of −β to +β in a vertical direction. In one example, in an attempt to provide the scan pattern 700 of FIG. 7A, the LiDAR system 700 is operated with α being 130 degrees and β being 1 degree. For example, the first partial scan pattern 702a covers a horizontal (or Azimuth) optical range of 0 to 130 degrees with a vertical (or Elevation) optical range of 2 to 4 degrees (e.g., ±1 degree). Likewise, the second partial scan pattern 702b covers a horizontal optical range of 0 to 130 degrees with a vertical optical range of 0 to 2 degrees, the third partial scan pattern 702c covers a horizontal optical range of 0 to 130 degrees with a vertical optical range of −2 to 0 degrees, and the fourth partial scan pattern 702d covers a horizontal optical range of 0 to 130 degrees with a vertical optical range of −4 to −2 degrees. The plurality of partial scan patterns 702 may be combined to form the scan pattern 700. In one example, the scan pattern 700 has a horizontal optical range of 130 degrees with a vertical scan range of 8 degrees. However, being that a single reflective surface (e.g., the scanning mirror 606) is used to scan in both the horizontal and vertical directions, the actual scan pattern may include undesired compression.

FIG. 7B illustrates an actual scan pattern 750 of the LiDAR system 600, according to some embodiments. In one example, the scan pattern 750 corresponds to an actual scan pattern provided by the LiDAR system 600 when controlled (or operated) in an attempt to provide the ideal scan pattern 700 of FIG. 7A. The scan pattern 750 includes a plurality of partial scan patterns 752 representing the actual trajectories of the transmit beams when the scanning mirror 606 is controlled in an attempt to provide the ideal pattern 700. As shown, the plurality of partial scan patterns 752 may experience vertical compression at each end of the horizontal scan range. In other words, as the scanning mirror 606 rotates about the first axis 610 to adjust the horizontal scan direction (e.g., towards 0 or α degrees), the apparent vertical deflection provided by the scanning mirror 606 may decrease while approaching each end of the horizontal scan range.

As such, the actual scan pattern 750 may include at least one high compression area 754. In one example, the high compression areas 754 can be defined relative to a. For example, a first high compression area 754a may be defined as the horizontal optical range below 0.2*α degrees (e.g., 26 degrees); however, in other examples, the first high compression area 754a may be defined differently. In the first high compression area 754a, the apparent vertical deflection provided by the scanning mirror 606 may be 70% or less of the desired (or commanded) vertical deflection. For example, when positioned to provide+1 degree of vertical deflection, the scanning mirror 606 may provide approximately +0.7 degrees of actual vertical deflection. Likewise, a second high compression area 754b may be defined as the horizontal optical range above 0.5*α degrees (e.g., 65 degrees); however, in other examples, the second high compression area 754b may be defined differently. In the second high compression area 754b, the apparent vertical deflection provided by the scanning mirror 606 may be 30% or less of the desired (or commanded) vertical deflection. For example, when positioned to provide+1 degree of vertical deflection, the scanning mirror 606 may provide approximately +0.3 degrees of actual vertical deflection. Due to the compression in the transmit beam trajectories, undesired gaps or holes can appear in the scan pattern 750, particularly in the high compression areas 754. As such, the resolution and/or accuracy of the scan data collected from the scan pattern 750 may be reduced. Likewise, the quality of point clouds and images derived from the scan data may be degraded.

A drive waveform can be generated to adjust the deflection of the reflective surface (e.g., the scanning mirror 606) while correcting scan line compression. In one example, the drive waveform is generated based on a compression curve (or response) of the scanning mirror 606. The compression curve may be alternatively referred to as a deflection curve (or response) of the scanning mirror 606.

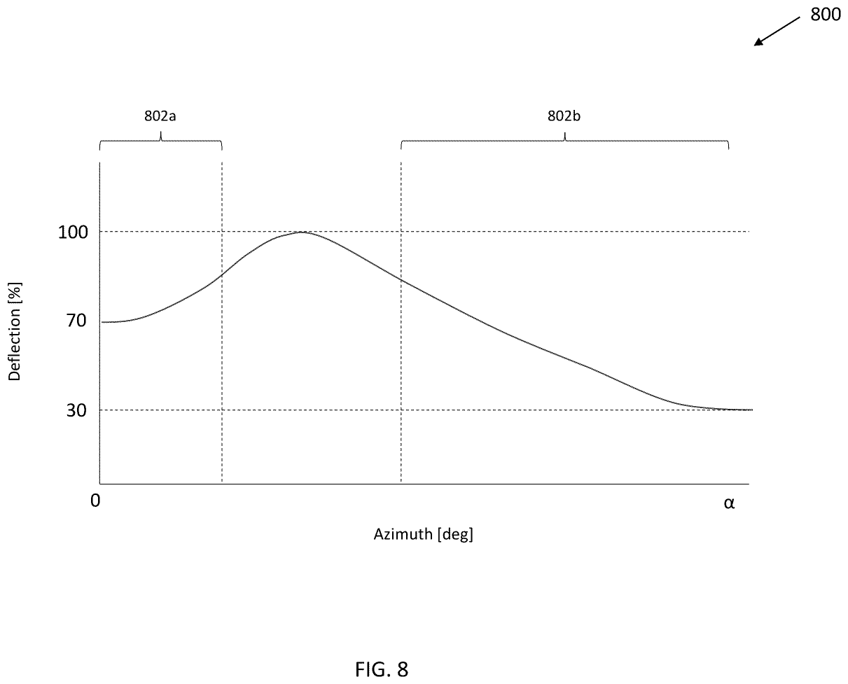

FIG. 8 illustrates an example compression profile 800, according to some embodiments. The compression profile (or curve) 800 represents the scan line compression of the scanning mirror 606 as a deflection percentage over the horizontal (or Azimuth) optical scan range. The deflection percentage represents the amount of vertical deflection provided by the scanning mirror 606 relative to the desired (or expected) amount of vertical deflection. For example, if the deflection percentage is 70%, the scanning mirror 606 would provide approximately 0.7 degrees of actual vertical deflection when controlled (or positioned) to provide+1.0 degree of vertical deflection.

In one example, the compression profile 800 is calculated from a reflection matrix corresponding to properties of the scanning mirror 606. In addition, the reflection matrix may represent properties of the LiDAR system configuration (e.g., the position of the light emission engine 602 relative to the scanning mirror 606). In some examples, the reflection matrix is derived using one or more closed form equations. In other examples, the compression profile 800 can be calculated via a physical or simulated characterization process. For example, the light emission engine 602 can be activated while the scanning mirror 606 is rotated about the first axis 610 to scan across the horizontal optical scan range from 0 to a degrees. At an interval (e.g., every 5 degrees), the scanning mirror 606 is positioned to provide a desired amount of vertical deflection. The actual deflection provided by the scanning mirror 606 can then be measured/observed. The deflection percentage is calculated for each measured deflection. In one example, each deflection percentage corresponds to the ratio of the measured deflection relative to the desired (or expected) deflection.

As shown in FIG. 8, high compression areas 802a, 802b can be identified from the compression profile 800. In one example, the high compression areas 802a, 802b correspond to the high compression areas 754a, 754b of FIG. 7B. The high compression areas 802a, 802b may represent regions of the horizontal optical range where the deflection percentage falls below a predetermined threshold (e.g., 85%, 75%, etc.).

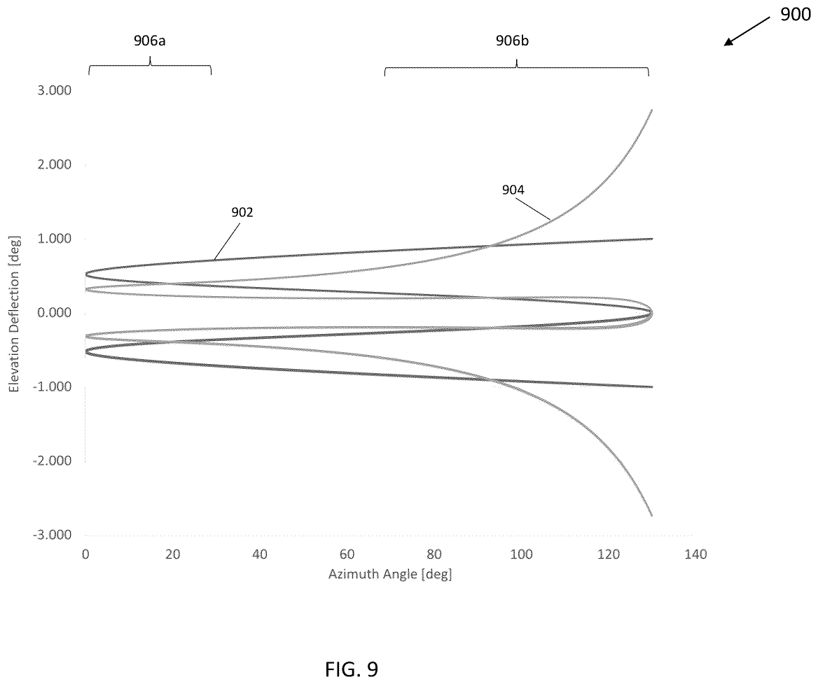

The compression profile 800 can be used to generate a drive waveform for controlling the scanning mirror 606 to correct scan line compression. FIG. 9 is a plot 900 including a desired scan pattern 902 and a drive waveform 904. In one example, the scan pattern 902 corresponds to the scan pattern of the transmit beam 608 of FIG. 6. In some examples, the scan pattern 902 may be similar to the partial scan patterns 702 of FIG. 7A. For example, the scan pattern 902 covers a horizontal (or Azimuth) optical range of 0 to 130 degrees with a vertical (or Elevation) optical range of −1 to +1 degrees (e.g., ±1 degrees).

As described above, the scanning mirror 606 is configured to receive one or more control signals (e.g., drive waveforms) to control the rotation of the scanning mirror 606 about the first axis 610 and the second axis 614. The control signal(s) may be used to operate the actuators 612, 616, or any other steering mechanisms associated with the scanning mirror 606. Rather than providing control signals that map directly to the desired scan pattern 902, the scanning mirror 606 can be controlled using the drive waveform 904 to prevent (or reduce) scan line compression in the actual scan pattern. In one example, the drive waveform 904 is based on a relationship between the compression profile 800 and the desired scan pattern 902. In some examples, the drive waveform 904 is a product of the desired scan pattern 902 and the reciprocal of the compression profile 800. For example, the vertical deflection of the drive waveform 904 across the horizontal optical scan range can be calculated using the following relationship:

$$D {W}_{v} ( n ) = \frac{S P ( n )}{C P ( n )}$$

where, DW_{ν} is the vertical deflection of the drive waveform 904, SP is the desired scan pattern 902, CP is the compression profile 800, and n is the horizontal scan angle.

In some examples, the drive waveform 904 is configured to adjust the amount of vertical deflection provided by the scanning mirror 606 at a variable rate based on the compression profile 800. For example, the drive waveform 904 may adjust the amount of vertical deflection provided by the scanning mirror 606 at a substantially linear rate over regions in the horizontal scan range with low or allowable compression (e.g., high deflection percentage). In some examples, the rate of the drive waveform 904 may be substantially similar to the rate of the desired scan pattern 902 in these regions of low compression. Conversely, the drive waveform 904 may adjust the amount of vertical deflection provided by the scanning mirror 606 at a non-linear rate over regions in the horizontal scan range with high compression (e.g., low deflection percentage). As shown in FIG. 9, the drive waveform 904 includes regions 906a and 906b where the vertical deflection of the scanning mirror 606 is increased or decreased at a non-linear rate. In certain examples, the vertical deflection of the scanning mirror 606 may be adjusted at an exponential rate (e.g., in region 906b). In one example, the non-linear regions 906a and 906b correspond to the high compression regions 802a, 802b of FIG. 8.

In some examples, the drive waveform 904 controls the scanning mirror 606 to prevent (or reduce) scan line compression in the actual scan pattern. By compensating for scan line compression, the drive waveform 904 enables the scanning mirror 606 (or the LiDAR system 600) to provide scan patterns as desired for data collection. In other words, the drive waveform 904 enables the LiDAR system 600 to achieve scan patterns that are substantially similar to the desired (or ideal) scan patterns. As such, the resolution and/or accuracy of the scan data collected using the scanning mirror 606 may be increased. Likewise, the quality of point clouds and images derived from the scan data can be improved. In addition, such improvements can be realized without a reliance on post-processing correction techniques, which can be highly complex, resource intensive, and performance limiting.

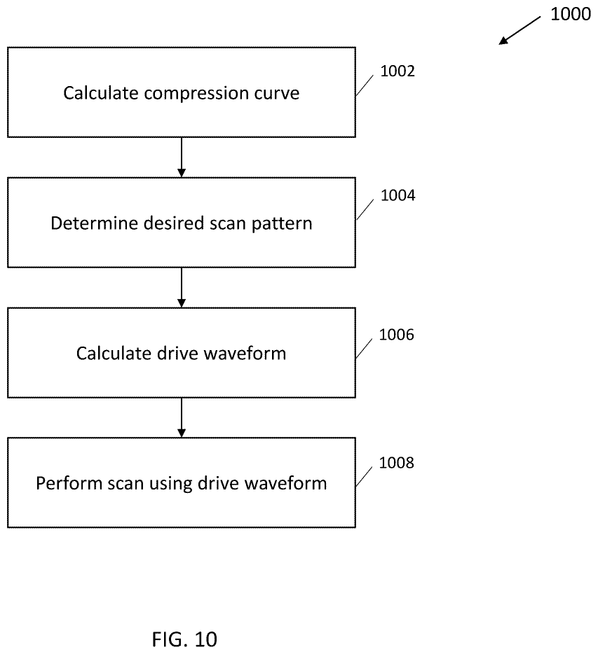

FIG. 10 is a flow diagram of a method 1000 for generating a drive waveform to correct scan line compression, according to some embodiments. In one example, the method 1000 is used in connection with LiDAR systems that include a single reflective surface that is actuated to scan in both the horizontal and vertical dimensions (e.g., LiDAR system 600 of FIG. 6).

At step 1002, the compression curve (e.g., compression profile 800) for the LiDAR system 600 is calculated. In one example, the compression profile 800 represents the scan line compression of the scanning mirror 606 as a deflection percentage over the horizontal (or Azimuth) optical scan range. The deflection percentage represents the actual amount of vertical deflection provided by the scanning mirror 606 relative to the desired (or expected) amount of vertical deflection. In some examples, the compression profile 800 is calculated from a reflection matrix corresponding to properties of the scanning mirror 606 and the configuration of the LiDAR system 600. In other examples, the compression profile 800 can be calculated via a physical or simulated characterization process.

At step 1004, a desired scan pattern is determined. In one example, the desired scan pattern corresponds to the desired trajectory for the transmit beam 608. For example, the desired scan pattern may cover a horizontal (or Azimuth) optical range of 0 to 130 degrees with a vertical (or Elevation) optical range of −1 to +1 degrees (e.g., ±1 degrees). In other examples, the desired scan pattern may correspond to a plurality of partial scan patterns that form a combined scan pattern (e.g., the scan pattern 700 of FIG. 7A). In some examples, the desired scan pattern may cover a FOV of the LiDAR system 600; however, in other examples, the desired scan pattern may cover a only a portion of the FOV of the LiDAR system 600.

At step 1006, the drive waveform (e.g., drive waveform 904) for controlling the scanning mirror 606 is calculated. The scanning mirror 606 can be controlled using the drive waveform 904 to prevent (or reduce) scan line compression in the actual scan pattern. In one example, the drive waveform 904 is based on a relationship between the compression profile 800 and the desired scan pattern 902. In some examples, the drive waveform 904 is a product of the desired scan pattern 902 and the reciprocal of the compression profile 800. In some examples, the drive waveform 904 adjusts the amount vertical deflection provided by the scanning mirror 606 at a variable rate based on the compression profile 800. For example, the drive waveform 904 may adjust the amount of vertical deflection provided by the scanning mirror 606 at a substantially linear rate over regions in the horizontal scan range with low or allowable compression (e.g., high deflection percentage). Conversely, the drive waveform 904 may adjust the amount of vertical deflection provided by the scanning mirror 606 at a non-linear rate over regions in the horizontal scan range with high compression (e.g., low deflection percentage).

At step 1008, the scanning mirror 606 is controlled to perform a scan using the drive waveform 904. In one example, the drive waveform 904 is used to operate the actuators 612, 616, or any other steering mechanisms associated with the scanning mirror 606. In some examples, control signals for operating the actuators 612, 616 (or any other steering mechanisms) can be derived from the drive waveform 904. The drive waveform 904 enables the scanning mirror 606 (or the LiDAR system 600) to achieve actual scan patterns that are substantially similar to the desired (or ideal) scan patterns. The drive waveform 904 controls the scanning mirror 606 such that scan line compression in the actual scan pattern is prevented (or reduced).

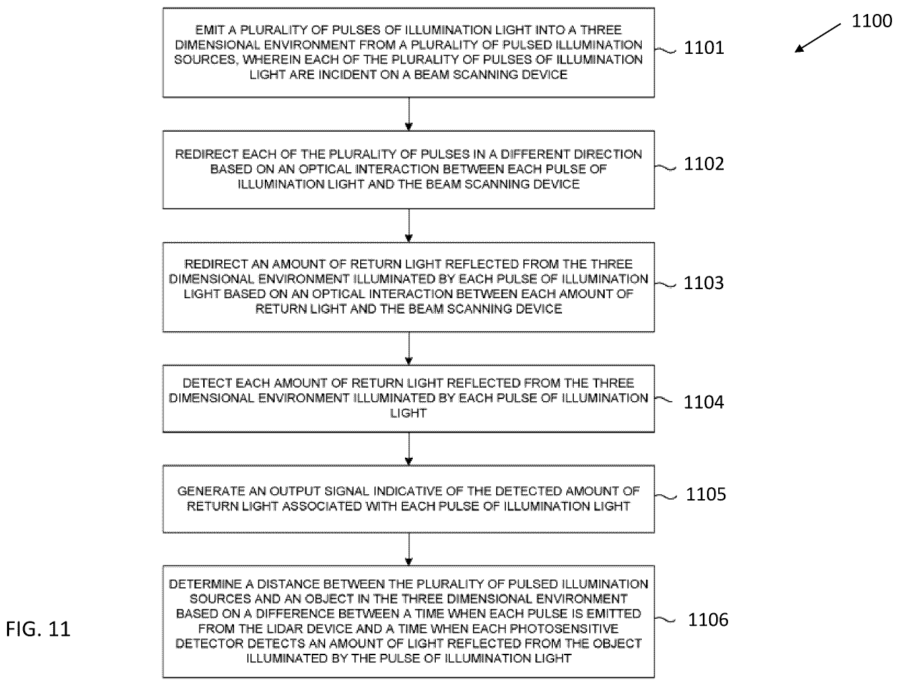

FIG. 11 illustrates a flowchart of a method 1100 suitable, according to some embodiments, for implementation by a LiDAR system as described herein. In some embodiments, the LiDAR system 100 depicted in FIG. 1 is operable in accordance with method 1100 illustrated in FIG. 11. However, in general, the execution of method 1100 is not limited to the embodiments of the LiDAR system 100 described with reference to FIG. 1. In some examples, a LiDAR system including the LiDAR devices and/or the device arrays provided herein may be operable in accordance with method 1100 illustrated in FIG. 11. For example, the LiDAR system 600 may be operable in accordance with method 1100. These illustrations and corresponding explanation are provided by way of example as many other embodiments and operational examples may be contemplated.

In step 1101, a plurality of beams of illumination light (e.g., pulsed illumination light) are emitted into a 3-D environment from a plurality of illumination sources (e.g., pulsed illumination sources). Each of the plurality of beams of illumination light is incident on a beam scanning device.

In step 1102, each of the plurality of beams of illumination light is redirected in a different direction based on an optical interaction between each beam of illumination light and the beam scanning device.

In step 1103, an amount of return light reflected from the 3-D environment illuminated by each beam of illumination light is redirected based on an optical interaction between each amount of return light and the beam scanning device.

In step 1104, each amount of return light reflected from the 3-D environment illuminated by each beam of illumination light is detected (e.g., by a photosensitive detector).

In step 1105, an output signal indicative of the detected amount of return light associated with each beam of illumination light is generated.

In step 1106, a distance between the plurality of illumination sources and one or more objects in the 3-D environment is determined based on a difference between a time when each beam of illumination light is emitted from the LiDAR device and a time when each photosensitive detector detects an amount of light reflected from the object illuminated by the beam of illumination light.

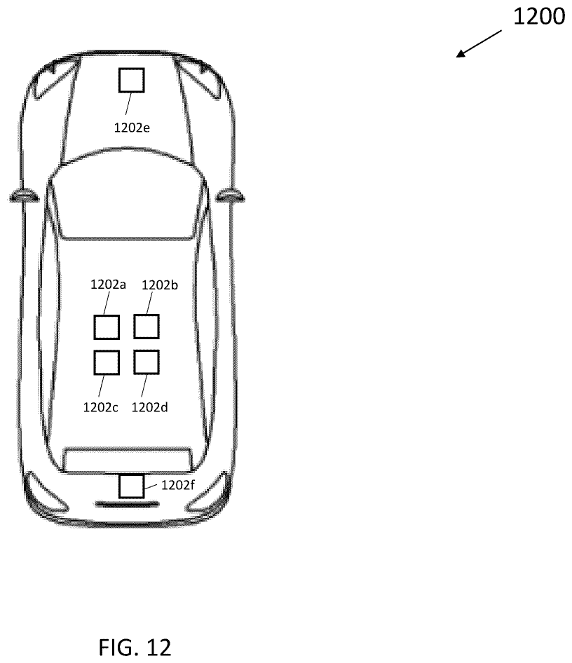

FIG. 12 illustrates a vehicle 1200 having a plurality of sensors 1202, according to some embodiments. As shown, a first sensor 1202a, a second sensor 1202b, a third sensor 1202c, and a fourth sensor 1202d may be positioned in a first location on (or inside) the vehicle 1200 (e.g., the roof). Likewise, a fifth sensor 1202e may be positioned in a second location on (or inside) the vehicle 1200 (e.g., the front of the vehicle 1200) and a sixth sensor 1202f may be positioned in a third location on (or inside) the vehicle 1200 (e.g., the back of the vehicle 1200). In other examples, a different number or configuration of sensors may be used.

In some examples, at least one sensor of the plurality of sensors 1202 is configured to provide (or enable) 3-D mapping of the vehicle's surroundings. In certain examples, at least one sensor of the plurality of sensors 1202 is used to provide navigation for the vehicle 1200 within an environment. In one example, each sensor 1202 includes at least one LiDAR system, device, or chip. The LiDAR system(s) included in each sensor 1202 may correspond to the LiDAR system 600 of FIG. 6. The LiDAR system(s) included in each sensor 1202 may be operable in accordance with the method 1000 of FIG. 10. In some examples, at least one sensor of the plurality of sensors 1202 may be a different type of sensor (e.g., camera, radar, etc.). In one example, the vehicle 1200 is a car; however, in other examples, the vehicle 1200 may be a truck, boat, plane, drone, vacuum cleaner (e.g., robot vacuum cleaner), robot, train, tractor, ATV, or any other type of vehicle or moveable object.

As described above, improved systems and methods for correcting scan line compression in LiDAR systems using single reflective surfaces are provided. In at least one embodiment, a drive waveform is generated to adjust the deflection of the reflective surface to correct scan line compression. In one example, the deflection of the reflective surface is adjusted by the drive waveform at a variable rate. In some examples, the deflection of the reflective surface is adjusted at a non-linear rate over one or more geometrically compressed regions of the FOV of the LiDAR system.

### Some Examples of Computing Devices and Information Handling Systems

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), network storage device, or any other suitable device and may vary in size, shape, performance, functionality, and price.

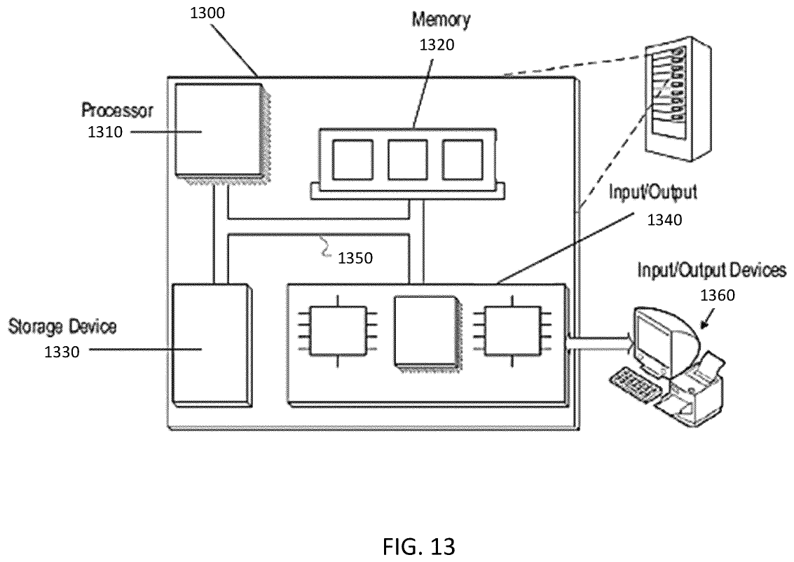

FIG. 13 is a block diagram of an example computer system 1300 that may be used in implementing the technology described in this document. General-purpose computers, network appliances, mobile devices, or other electronic systems may also include at least portions of the system 1300. The system 1300 includes a processor 1310, a memory 1320, a storage device 1330, and an input/output device 1340. Each of the components 1310, 1320, 1330, and 1340 may be interconnected, for example, using a system bus 1350. The processor 1310 is capable of processing instructions for execution within the system 1300. In some implementations, the processor 1310 is a single-threaded processor. In some implementations, the processor 1310 is a multi-threaded processor. The processor 1310 is capable of processing instructions stored in the memory 1320 or on the storage device 1330.

The memory 1320 stores information within the system 1300. In some implementations, the memory 1320 is a non-transitory computer-readable medium. In some implementations, the memory 1320 is a volatile memory unit. In some implementations, the memory 1320 is a non-volatile memory unit.

The storage device 1330 is capable of providing mass storage for the system 1300. In some implementations, the storage device 1330 is a non-transitory computer-readable medium. In various different implementations, the storage device 1330 may include, for example, a hard disk device, an optical disk device, a solid-date drive, a flash drive, or some other large capacity storage device. For example, the storage device may store long-term data (e.g., database data, file system data, etc.). The input/output device 1340 provides input/output operations for the system 1300. In some implementations, the input/output device 1340 may include one or more of a network interface device, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1360. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1330 may be implemented in a distributed way over a network, for example as a server farm or a set of widely distributed servers, or may be implemented in a single computing device.

Although an example processing system has been described in FIG. 13, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

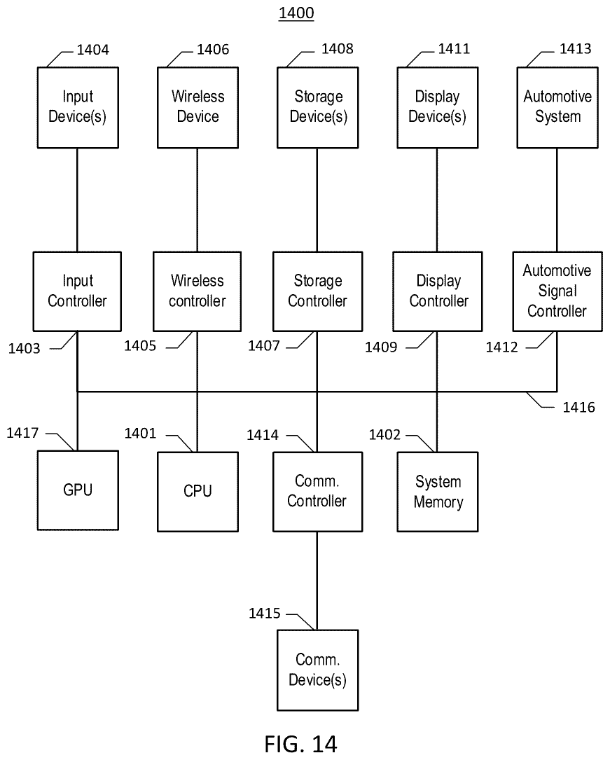

FIG. 14 depicts a simplified block diagram of a computing device/information handling system (or computing system) according to embodiments of the present disclosure. It will be understood that the functionalities shown for system 1400 may operate to support various embodiments of an information handling system—although it shall be understood that an information handling system may be differently configured and include different components.

As illustrated in FIG. 14, system 1400 includes one or more central processing units (CPU) 1401 that provide(s) computing resources and control(s) the computer. CPU 1401 may be implemented with a microprocessor or the like, and may also include one or more graphics processing units (GPU) 1417 and/or a floating point coprocessor for mathematical computations. System 1400 may also include a system memory 1402, which may be in the form of random-access memory (RAM), read-only memory (ROM), or both.

A number of controllers and peripheral devices may also be provided. For example, an input controller 1403 represents an interface to various input device(s) 1404, such as a keyboard, mouse, or stylus. There may also be a wireless controller 1405, which communicates with a wireless device 1406. System 1400 may also include a storage controller 1407 for interfacing with one or more storage devices 1408, each of which includes a storage medium such as a magnetic tape or disk, or an optical medium that might be used to record programs of instructions for operating systems, utilities, and applications, which may include embodiments of programs that implement various aspects of the techniques described herein. Storage device(s) 1408 may also be used to store processed data or data to be processed in accordance with some embodiments. System 1400 may also include a display controller 1409 for providing an interface to a display device 1411, which may be a cathode ray tube (CRT), a thin film transistor (TFT) display, or other type of display. The computing system 1400 may also include an automotive signal controller 1412 for communicating with an automotive system 1413. A communications controller 1414 may interface with one or more communication devices 1415, which enables system 1400 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN), or through any suitable electromagnetic carrier signals including infrared signals.

In the illustrated system, all major system components may connect to a bus 1416, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A light detection and ranging (LiDAR) device, comprising:
at least one illumination source configured to emit illumination light;
an optical scanning device disposed in an optical path of the at least one illumination source to redirect the illumination light emitted by the at least one illumination source from the LiDAR device into a three-dimensional (3-D) environment;
at least one scanning mechanism configured to rotate the optical scanning device about at least one axis; and
at least one controller configured to:
determine a desired scan pattern for the LiDAR device;
generate at least one drive waveform corresponding to (i) the desired scan pattern and (ii) a scan line compression profile of the optical scanning device; and
operate the at least one scanning mechanism based on the at least one drive waveform to provide the desired scan pattern.

2. The LiDAR device of claim 1, wherein the at least one controller, in operating the at least one scanning mechanism, is configured to control (i) a first scanning mechanism configured to rotate the optical scanning device about a first axis to deflect the illumination light in a first scan direction and (ii) a second scanning mechanism configured to rotate the optical scanning device about a second axis to deflect the illumination light in a second scan direction, the second axis being orthogonal to the first axis.

3. The LiDAR device of claim 2, wherein the scan line compression profile corresponds to a deflection percentage of the optical scanning device over an optical scan range in the first scan direction.

4. The LiDAR device of claim 3, wherein the deflection percentage represents an actual amount of deflection provided by the optical scanning device in the second scan direction relative to a desired amount of deflection to be provided by the optical scanning device in the second scan direction.

5. The LiDAR device of claim 4, wherein the at least one drive waveform is configured to compensate for differences between the desired amount of deflection and the actual amount of deflection to provide the desired scan pattern.

6. The LiDAR device of claim 3, wherein the scan line compression profile of the optical scanning device provides an indication of at least one geometrically compressed region in a field of view of the LiDAR device.

7. The LiDAR device of claim 6, wherein the at least one geometrically compressed region corresponds to at least one portion of the optical scan range in the first scan direction.

8. The LiDAR device of claim 6, wherein the at least one drive waveform is configured to adjust an amount of deflection provided by the optical scanning device in the second scan direction at a variable rate based on the scan line compression profile.

9. The LIDAR device of claim 8, wherein the at least one drive waveform is configured to adjust the amount of deflection provided by the optical scanning device in the second scan direction at a non-linear rate over the at least one geometrically compressed region.

10. The LIDAR device of claim 8, wherein the at least one drive waveform is configured to adjust the amount of deflection provided by the optical scanning device in the second scan direction at a substantially linear rate outside of the at least one geometrically compressed region.

11. A method of operating a light detection and ranging (LiDAR) device, the method comprising:
determining a desired scan pattern for the LiDAR device;
emitting illumination light from at least one illumination source;
generating at least one drive waveform corresponding to (i) the desired scan pattern and (ii) a scan line compression profile of an optical scanning device disposed in an optical path of the at least one illumination source, the optical scanning device being configured to redirect the illumination light emitted by the at least one illumination source from the LiDAR device into a three-dimensional (3-D) environment; and
controlling at least one scanning mechanism based on the at least one drive waveform, the at least one scanning mechanism being configured to rotate the optical scanning device about at least one axis to provide the desired scan pattern.

12. The method of claim 11, wherein controlling the at least one scanning mechanism comprises controlling (i) a first scanning mechanism configured to rotate the optical scanning device about a first axis to deflect the illumination light in a first scan direction and (ii) a second scanning mechanism configured to rotate the optical scanning device about a second axis to deflect the illumination light in a second scan direction, the second axis being orthogonal to the first axis.

13. The method of claim 12, wherein the scan line compression profile corresponds to a deflection percentage of the optical scanning device over an optical scan range in the first scan direction.

14. The method of claim 13, wherein the deflection percentage represents an actual amount of deflection provided by the optical scanning device in the second scan direction relative to a desired amount of deflection to be provided by the optical scanning device in the second scan direction.

15. The method of claim 14, wherein the at least one drive waveform is configured to compensate for differences between the desired amount of deflection and the actual amount of deflection to provide the desired scan pattern.

16. The method of claim 13, wherein the scan line compression profile of the optical scanning device provides an indication of at least one geometrically compressed region in a field of view of the LiDAR device.

17. The method of claim 16, wherein the at least one geometrically compressed region corresponds to at least one portion of the optical scan range in the first scan direction.

18. The method of claim 16, wherein the at least one drive waveform is configured to adjust an amount of deflection provided by the optical scanning device in the second scan direction at a variable rate based on the scan line compression profile.

19. The method of claim 18, wherein the at least one drive waveform is configured to adjust the amount of deflection provided by the optical scanning device in the second scan direction at a non-linear rate over the at least one geometrically compressed region.

20. The method of claim 18, wherein the at least one drive waveform is configured to adjust the amount of deflection provided by the optical scanning device in the second scan direction at a substantially linear rate outside of the at least one geometrically compressed region.

21. A vehicle, comprising:
at least one LIDAR device of claim 1, wherein each LIDAR device is configured to provide navigation and/or mapping for the vehicle and is disposed in an interior of the vehicle and/or on an exterior of the vehicle.
